(19) United States
(12) Patent Application Publication
(10) Pub. No.: US 2009/0034429 A1
(43) Pub. Date: Feb. 5, 2009

(54) PACKET COMMUNICATION APPARATUS AND COMMUNICATION LINE QUALITY ANALYZING METHOD

(75) Inventor: Natsue YOKOGAWA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kanagawa (JP)

(21) Appl. No.: 12/182,198

(22) Filed: Jul. 30, 2008

(30) Foreign Application Priority Data
Jul. 30, 2007 (JP) 2007-197643

(51) Int. Cl. H04L 12/26

(52) U.S. Cl. 370/253

(57) ABSTRACT

A packet communication apparatus includes a test packet header generating section configured to generate a header in an enable state. A state machine sets the test packet header generating section to the enable state when a test packet transmission flag is set. An FCS (Frame Check Sequence) calculating section generates a data in a FCS field to add to the header, and generates a variable length test packet having a plurality of FCS fields. A transmitting section transmits test packets sequentially.

### INCORPORATION BY REFERENCE

This application claims priority on convention based on Japanese Patent Application No. 2007-197643. The disclosure thereof is incorporated herein by reference.

### BACKGROUND OF THE INVENTION

1. Field of the Invention

The present invention relates to a packet communication apparatus, and more particularly to a packet communication apparatus that analyzes quality of a communication line.

2. Description of Related Art

In a packet communication line, a maximum packet length is predetermined on the basis of a standard, but an effective value of a circuit is not known unless it is actually checked. Also, an error of a packet can be determined but an erroneous area in the packet is difficult to determine. Accordingly, the effective value is determined while a packet length is variously changed.

Generally, a packet communication apparatus receives packets, and upon reception of a test packet, reads data in a data payload. Then, the packet communication apparatus reconfigures the test packet to output it. Subsequently, the packet communication apparatus compares the read data against held data, and analyzes them to obtain a test result of a transmission line.

A typical packet communication apparatus performs a complicated process of the test packet, and therefore has a large circuit scale. Also, the same test packet has a fixed value in length, and is therefore inappropriate for detection of quality of the communication line based on the packet length.

As a related art, a “Test system for transmission line” is described in Japanese Patent Application Publication (JP-P1989-050641A). In this related art, a test frame is transmitted from a directly connected node processor to a common transmission line and includes as a data, a transfer sequence for forming a transfer path to circulate a plurality of node processors within a network. Any of the node processors having received the test frame from the common communication line, identifies it as the test frame, and transfers the test frame to the next node processor according to the transfer sequence included in the test frame. The node processor having sent the test frame identifies normality of the transmission line within a range of the transfer on the basis of a fact that the test frame has been transferred to a directly connected node processor within a predetermined time period.

Also, in Japanese Patent Application Publication (JP-P2004-120190A), “Line connection device and communication system” is disclosed. In this related art, a first line connection device performs a calculation using a specified portion of frame format data transmitted from a user LAN to obtain a CRC value, and attaches the CRC value to the tail of the data to transmit it to a dedicated line. A second line connection device uses a specified part of data transmitted through the dedicated line to perform a calculation, and compares the obtained value with the CRC value attached to the tail of the received data.

### SUMMARY

In a first aspect of the present invention, a packet communication apparatus includes a test packet header generating section configured to generate a header in an enable state; a state machine configured to set the test packet header generating section to the enable state when a test packet transmission flag is set; an FCS (Frame Check Sequence) calculating section configured to generate a data in a FCS field to add to the header, and to generate a variable length test packet having a plurality of FCS fields; and a transmitting section configured to transmit test packets sequentially.

In a second aspect of the present invention, a packet communication apparatus includes a packet processing section configured to receive packets from outside, to determine a kind of each of the received packets and a packet length of the received packet, and to determine a number of FCS (Frame Check Sequence) fields when the received packet is a test packet; a FCS calculating section configured to receive the received packet and the determined number of FCS fields and to perform a calculation to the FCS fields; a FCS calculation counter configured to count a number of times of the calculation which is repeated in the FCS calculating section; and a calculation result collating section configured to collate calculation results by the FCS calculating section sequentially when the count by the FCS calculation counter becomes equal to the determined number of FCS fields, and to output a collation result as a test packet data.

In a third aspect of the present invention, a method of analyzing communication line quality, is achieved by receiving packets from outside; by determining a kind of each of the received packets and a packet length of the received packet, and determining a number of FCS (Frame Check Sequence) fields when the received packet is a test packet; by receiving the received packet and the determined number of FCS fields and performing a calculation to the FCS fields; by counting a number of times of the calculation which is repeated; by collating calculation results by the FCS calculating section sequentially when the count by the FCS calculation counter becomes equal to the determined number of FCS fields, to output a collation result as a test packet data.

A packet communication apparatus is adapted to transmit/receive a variable length test packet including a plurality of FCS (Frame Check Sequence) fields following a data payload.

A maximum packet length as an effective value of a line can be obtained, rather than that predetermined on a basis of a standard.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a diagram illustrating a field configuration and a calculation range of a test packet;

FIG. 2 is a schematic configuration diagram illustrating a packet transmission circuit in a first embodiment;

FIG. 3 is a schematic configuration diagram illustrating a packet reception circuit in the first embodiment;

FIG. 4 is a diagram illustrating an error existence region determinable from the calculation range and a calculation check result;

FIG. 5 is a diagram showing a flowchart illustrating operations of a transmission side circuit;

FIG. 6 is a diagram showing a flowchart illustrating operations of a reception side circuit in the first embodiment;

FIG. 7 is a diagram illustrating a packet reception circuit in a second embodiment; and

FIG. 8 is a diagram showing a flowchart illustrating operations of a reception side circuit in the second embodiment.

### DESCRIPTION OF THE PREFERRED EMBODIMENTS

Hereinafter, a communication apparatus according to a first embodiment of the present invention will be described in detail with reference to the accompanying drawings.

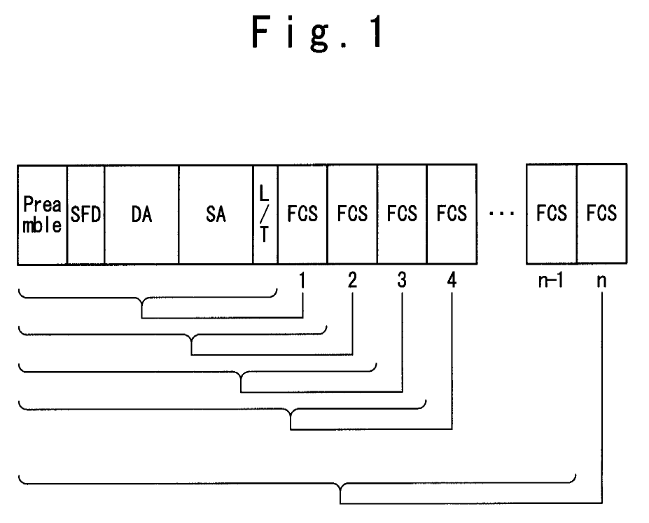

Referring to FIG. 1, a frame configuration of a test packet in the present invention will be described. The test packet includes a preamble field, a start frame delimiter (SFD), a destination address (DA), a source address (SA), a length/type (L/T) field, and a frame check sequence field (FCS).

The Preamble indicates a synchronization flag for clock synchronization, located at a head of a frame. The Start Frame Delimiter (SFD) field indicates that the head of the frame starts after this field. The Preamble field and Start Frame Delimiter field are predetermined on the basis of a standard. The Destination Address (DA) field indicates a destination address of the packet. The Source Address (SA) field indicates an address of a source host of the packet. The Length/Type (L/T) field indicates a size of the entire packet. The Frame Check Sequence (FCS) field indicates a checksum for error detection. In the present invention, one test packet always includes a plurality of the FCS fields. Each of the FCS fields has a calculation range from the head of the packet to a byte immediately before that FCS field.

A packet communication apparatus 100 of the present invention includes at least one of a transmission side circuit 10 and a reception side circuit 20. The transmission side circuit 10 is a packet transmission circuit for transmitting a test packet. The reception side circuit 20 is a packet reception circuit for receiving the test packet. It should be noted that the transmission side circuit 10 and reception side circuit 20 may be integrated as a transmission/reception circuit. Examples of the packet communication apparatus 100, the transmission side circuit 10, and the reception side circuit 20 may include electronic circuits provided with a communication function, terminal apparatuses such as a computer, and relay apparatuses such as a router. Also, it may be a communication interface such as an NIC (Network Interface Card).

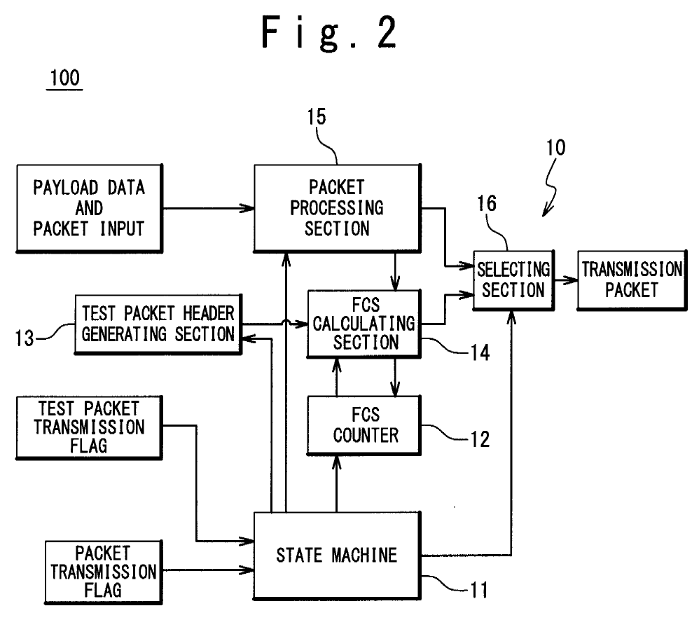

Referring to FIG. 2, a schematic configuration diagram of the transmission side circuit 10 is described.

The transmission side circuit 10 includes a state machine 11, a counter for counting the number of loaded FCSs (hereinafter to be referred to as a FCS counter) 12, a test packet header generating section 13, an FCS calculating section 14, a packet processing section 15, and a selecting (SEL) section 16.

The state machine 11 changes each of the sections to a plurality of predetermined states in a predetermined sequence according to a predetermined condition. The FCS counter 12 exchanges a “count enable” signal and a “carry” signal with the FCS calculating section 14. When being set to an enable state, the test packet header generating section 13 generates a packet header to transfer it to the FCS calculating section 14. The FCS calculating section 14 receives the header from the test packet header generating section 13 to generate a test packet and data of FCS fields in the packet. The packet processing section 15 generates data of fields of a transmission packet other than the FCS fields. The selecting section 16 switches transmission data according to the state machine 11.

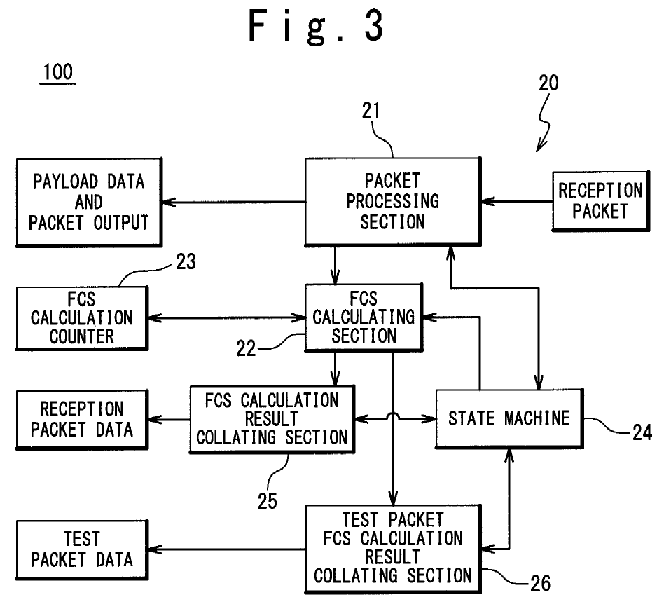

Referring to FIG. 3, a configuration of the reception side circuit 20 will be described. The reception side circuit 20 includes a packet processing section 21, an FCS calculating section 22, an FCS calculation counter for counting the number of times of FCS calculation 23, a state machine 24, an FCS calculation result collating section 25, and a test packet FCS calculation result collating section 26.

The packet processing section 21 outputs data of a received packet to the other sections. The FCS calculating section 22 calculates data in the FCS fields. In the calculation, the data in one FCS field is calculated through one calculation. At this time, according to a calculation range of the FCS field, the data from the head of the packet to a byte immediately before the FCS field is subjected to the calculation. The FCS calculation counter 23 counts the number of times of calculations in the FCS calculating section 22, and exchanges a “count enable” signal and a “carry” signal with the FCS calculating section 22. The state machine 24 changes each of the sections to a plurality of predetermined states in a predetermined sequence according to a predetermined condition. The FCS calculation result collating section 25 collates a calculation result other than that of the test packet. The test packet FCS calculation result collating section 26 collates the calculation result of the test packet.

It should be noted that an operation of each of the sections of the transmission side circuit 10 and reception side circuit 20 may be performed on a basis of a program executed by a computer.

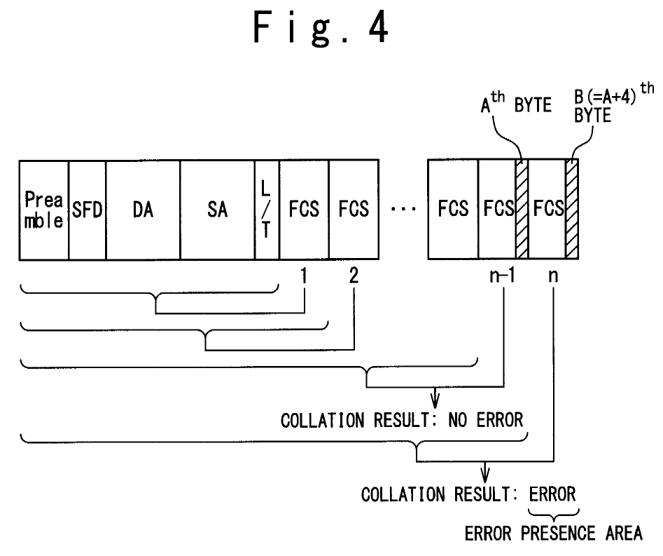

Referring to FIG. 4, a diagram for determining an error existence region in the test packet is described.

The test packet illustrated in FIG. 4 includes the preamble, SFD, DA, SA, L/T, and FCS fields. Descriptions of them are the same as those in FIG. 1. It is assumed that a byte length in case of an FCS load number (n−1) is A bytes (A=14+4×(n−1)), and the byte length in case of an FCS load number n is B bytes (B=14+4×n). Here, n indicates the number of FCS fields in the test packet (n≧2). That is, a total byte length of the Preamble, SFD, DA, SA and L/T fields is supposed to be 14 bytes, and the byte length of each FCS field to be 4 bytes.

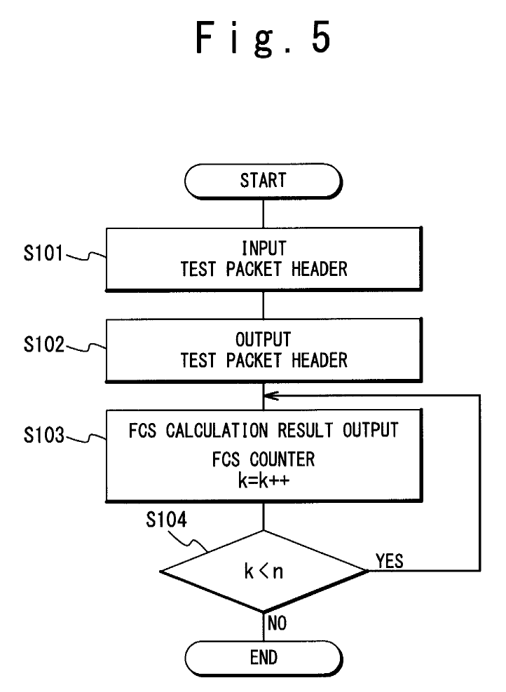

Referring to FIG. 5, an operation in the transmission side circuit 10 illustrated in FIG. 2 will be described.

### (1) Step S101

When a test packet transmission flag is set, the state machine 11 sets the test packet header generating section 13 to the enable state. In the enable state, the test packet header generating section 13 generates the header for the test packet. Here, the header includes the Preamble, SFD, DA, SA, and L/T fields.

### (2) Step S102

After generating the header of the test packet, the test packet header generating section 13 outputs the header to the FCS calculating section 14. The FCS calculating section 14 generates FCS fields to add them to the header. That is, the FCS fields are added to the test packet.

### (3) Step S103

Meanwhile, the state machine 11 switches the states of the FCS calculating section 14 and the SEL section 16. The SEL section 16 sequentially receives and transmits portions of the test packet, which have been subjected to the calculation in the FCS calculating section 14. That is, the SEL section 16 sequentially transmits the portions of the test packet after completion of the generation and addition of the FCS fields to the header by the FCS calculating section 14. Also, during the calculation in the FCS calculating section 14, the FCS counter 12 counts the number of the FCS fields having been added to the header by the FCS calculating section 14, and increments a count value k.

### (4) Step S104

When the count value k reaches a predetermined number n, the FCS counter 12 stops the calculation by the FCS calculating section 14, and informs the count up to the state machine 11. That is, when the counted value reaches a predetermined threshold, the FCS counter 12 ends the counting operation and notifies the state machine 11. In response to the notification, the state machine 11 switches the states of the FCS calculating section 14 and the SEL section 16. In other words, when the count value k of the FCS counter 12 reaches the predetermined number n, the generation and addition of the FCS fields to the header by the FCS calculating section 14 ends.

It should be noted that it is not necessary to add a plurality of FCS fields to the transmission packets other than the test packet. For example, if the test packet transmission flag is not set, when the FCS calculating section 14 adds one FCS field to the transmission packet generated by the packet processing section 15, the state machine 11 switches the states of the FCS calculating section 14 and the SEL section 16 such that the SEL section 16 outputs the transmission packet.

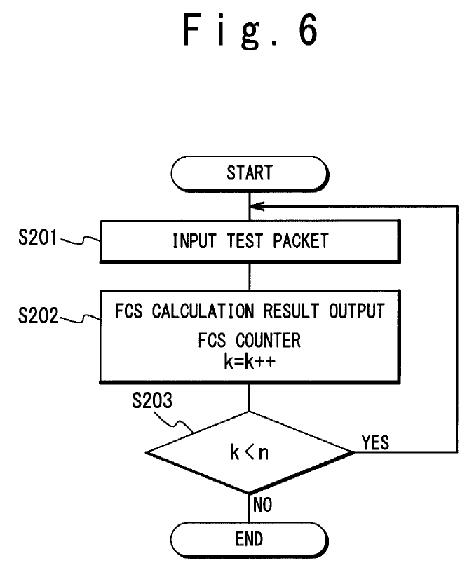

Referring to FIG. 6, an operation of the reception side circuit 20 illustrated in FIG. 3 is described.

### (1) Step S201

Upon reception of a packet, the packet processing section 21 determines a type and a length of the packet. If it is the test packet, the number of FCS fields obtained from the packet length (e.g., for the packet length of 54 bytes, (54−14)/4=10) is determined and the packet processing section 21 transfers the packet data and the number of FCS fields necessary for calculation to the FCS calculating section 22.

### (2) Step S202

The FCS calculating section 22 is connected to the FCS calculation number counter 23. The FCS calculation number counter 23 counts the number of calculations in the FCS calculating section 22, and increments a count value k by 1 (increment). When the count value k of the FCS calculation number counter 23 becomes equal to the number of the loads n, the FCS calculating section 22 outputs a calculation result to the test packet FCS calculation result collating section 26.

### (3) Step S203

The FCS calculating section 22 repeatedly performs the calculation until the count value k of the FCS calculation counter 23 becomes equal to the number of the FCS fields n. The test packet FCS calculation result collating section 26 sequentially collates the calculation results. Subsequently, the test packet FCS calculation result collating section 26 outputs the obtained collation results as a test packet data.

Giving a description with reference to FIG. 4, the test packet becomes a packet having a variable byte length of “a total of 14 bytes and a multiple of 4 bytes”. If a test packet having the byte length of B bytes or more is received and an error is generated in case that a summation of the calculation range and the FCS fields is equal to the B bytes (B=A+4) while no error is generated in case that the summation is equal to the A bytes, line quality can be guaranteed up to the packet length of A bytes. Also, in this case, it can be determined that the error is present in the last nth FCS field of the packet having the B byte length.

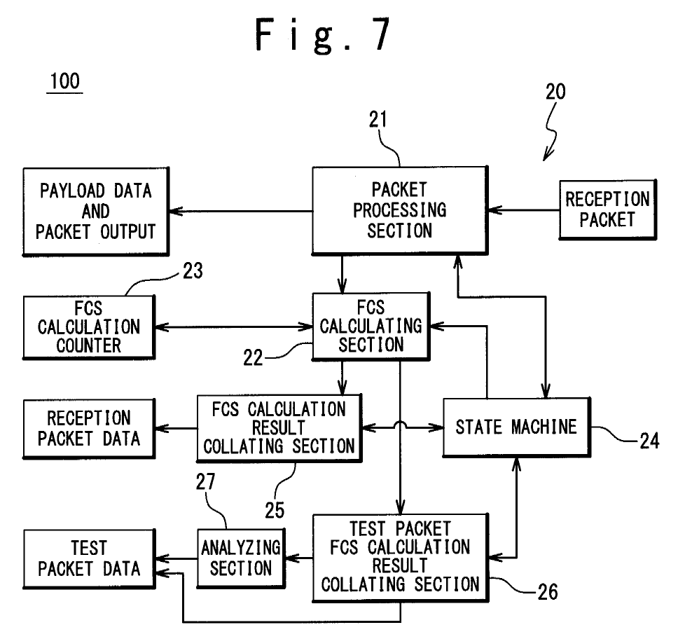

Next, a second embodiment of the present invention will be described. Referring to FIG. 7, the configuration of the reception side circuit 20 of the present embodiment will be described.

The reception side circuit 20 includes the packet processing section 21, the FCS calculating section 22, the FCS calculation counter 23, the state machine 24, the FCS calculation result collating section 25, the test packet FCS calculation result collating section 26, and an analysis section 27. The packet processing section 21, the FCS calculating section 22, the FCS calculation counter 23, the state machine 24, the FCS calculation result collating section 25, and the test packet FCS calculation result collating section 26 are the same as those illustrated in FIG. 3.

The analysis section 27 checks a collation result, and outputs a data indicating a region where an error is present.

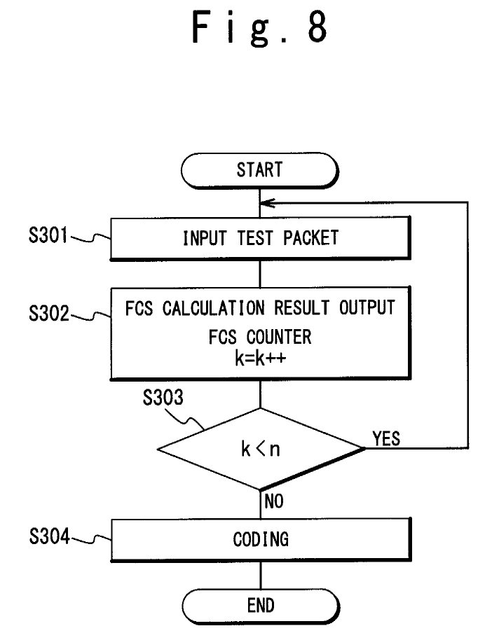

Referring to FIG. 8, an operation of the reception side circuit 20 in the second embodiment will be described.

### (1) Step S301

Upon receipt of a packet, the packet processing section 21 determines a type and a length of the packet. If it is the test packet, the packet processing section 21 determines the number of FCS fields from the packet length and transfers the packet and the number of the FCS fields to the FCS calculating section 22.

### (2) Step S302

The FCS calculating section 22 is connected to the FCS calculation counter 23. The FCS calculation counter 23 counts the number of times of the calculation in the FCS calculating section 22, and increments a count value k by “1” each calculation. When the count value k of the FCS calculation counter 23 becomes equal to the number of the FCS fields n, the FCS calculating section 22 outputs the calculation results to the test packet FCS calculation result collating section 26.

### (3) Step S303

The FCS calculating section 22 repeatedly performs the calculation until the count value k of the FCS calculation counter 23 becomes equal to the number of the FCS fields n. The test packet FCS calculation result collating section 26 sequentially checks results of the calculations. Subsequently, the test packet FCS calculation result collating section 26 outputs the obtained collation results as a test packet data.

### (4) Step S304

Also, the collation results are analyzed in the analysis section 27 according to an example of FIG. 4, and then encoded into numerical values representing a normally receivable region or byte length.

In this specification, the configuration is segmented for the description of the operations. However, the state machine 24 and the FCS calculating section 22 may be included in the packet processing section 21 in the reception side circuit 20. Also, the two calculation result collating sections (the FCS calculation result collating section 25 and the test packet FCS calculation result collating section 26) may be integrated, and further integrated with the packet processing section 21.

Further, the test packet header generating section 23 of the transmission circuit may also be integrated with the packet processing section 21. The circuit scale can be made smaller through the above integration.

It should be noted that the above respective embodiments may be combined.

In both of the transmission and reception circuits of the present invention, the FCS calculation results can be outputted each time of the calculation, so that it is only necessary to perform the series of calculations once from the head to the last. For this reason, the transmission and reception circuits do not require any buffer. Alternatively, the number of buffers in the transmission and reception circuits can be reduced.

Giving the description with reference to FIG. 4, the test packet becomes a packet having a variable byte length of “a total of 14 bytes and a multiple of 4 bytes”. Upon reception of the test packet having the byte length of B bytes or more, if there is no error in case of A bytes which is a summation of the calculation range and the FCS fields while there is an error in case of B bytes (B=A+4) which is a summation of the A bytes and 4 bytes, line quality can be guaranteed up to the calculation range and the FCS fields. Also, in this case, it can be determined that the error is present in the last n^{th} FCS field of the packet of the B byte length.

Also, in the present invention, by analyzing the error region in hardware, a load of a system can be reduced.

Further, in the present invention, a maximum packet length as an effective value of a transmission line can be obtained, rather than that predetermined on the basis of a standard, and even if a system is unstable, the packet length can be adjusted shorter to make communication. Still further, if the maximum packet length as the effective value of an actual communication line can be made longer than that based on the standard, the packet length can be made longer to increase transfer efficiency.

As described above, the packet communication apparatus of the present invention transmits/receives the variable length test packet including the plurality of FCS fields following the data payload.

Each of the FCS fields has the calculation range from the head of the packet to a byte immediately before the FCS field. Also, one packet is inevitably loaded with the plurality FCS fields. Consequently, the length of the packet is of (14+4n) bytes (n≧2).

The packet communication apparatus uses the already loaded FCS calculation part 4, and therefore processing is simplified, and the circuit size can be suppressed. Also, even if a system is unstable, the packet communication apparatus can be used, and also utilized for analyzing the quality based on the packet length because of the variable length packet, resulting in being useful for a network operation.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A packet communication apparatus comprising:
a test packet header generating section configured to generate a header in an enable state;
a state machine configured to set said test packet header generating section to the enable state when a test packet transmission flag is set;
an FCS (Frame Check Sequence) calculating section configured to generate a data in a FCS field to add to said header, and to generate a variable length test packet having a plurality of FCS fields; and
a transmitting section configured to transmit test packets sequentially.

2. The packet communication apparatus according to claim 1, further comprising:
an FCS counter configured to perform a counting operation of a number of FCS fields added to said header, to end the counting operation when the counted number of FCS fields reaches a predetermined number and to notify to said state machine that the counted number of FCS fields reaches the predetermined number,
wherein said state machine switches said FCS calculating section and said transmitting section in response to the notice from said FCS counter.

3. The packet communication apparatus according to claim 1, further comprising:
a packet processing section configured to receive a packet from an outside, to determine a kind of the received packet and a packet length of the received packet, to determine a number of FCS fields from the packet length of the received packet when the received packet is a test packet, and to send the received packet and the determined number of FCS fields to said FCS calculating section;
an FCS calculation counter configured to count a number of times of calculation to the FCS fields by said FCS calculating section; and
a calculation result collating section configured to collate calculation results by said FCS calculating section sequentially when the count by said FCS calculation counter becomes equal to the determined number of FCS fields, and to output a collation result as a test packet data.

4. The packet communication apparatus according to claim 3, further comprising:
an analysis section configured to analyze the collation result to output a data indicating a region where an error exists.

5. A packet communication apparatus comprising:
a packet processing section configured to receive packets from outside, to determine a kind of each of the received packets and a packet length of the received packet, and to determine a number of FCS (Frame Check Sequence) fields when the received packet is a test packet;
an FCS calculating section configured to receive the received packet and the determined number of FCS fields and to perform a calculation to the FCS fields;
an FCS calculation counter configured to count a number of times of the calculation which is repeated in said FCS calculating section;
a calculation result collating section configured to collate calculation results by said FCS calculating section sequentially when the count by said FCS calculation counter becomes equal to the determined number of FCS fields, and to output a collation result as a test packet data.

6. A method of analyzing communication line quality, comprising:
receiving packets from outside;
determining a kind of each of the received packets and a packet length of the received packet, and determining a number of FCS (Frame Check Sequence) fields when the received packet is a test packet;
receiving the received packet and the determined number of FCS fields and performing a calculation to the FCS fields;
counting a number of times of the calculation which is repeated;
collating calculation results by said FCS calculating section sequentially when the count by said FCS calculation counter becomes equal to the determined number of FCS fields, to output a collation result as a test packet data.

7. The method according to claim 6, wherein said collating comprises:
analyzing the collation result to output a data indicating a region where an error exists.

8. The method according to claim 6, further comprising:
generating a header when a test packet transmission flag is set;
generating a data in a FCS field to add to said header;
counting a number of FCS fields added to the header;
transmitting a test packet when the count reaches a predetermined value.
